(19) United States
(12) Patent Application Publication
(10) Pub. No.: US 2014/0112520 A1
(43) Pub. Date: Apr. 24, 2014

(54) INTEGRATED EARBUDS AND EARPLUGS, AND METHODS, SYSTEMS, AND KITS ASSOCIATED THEREWITH

(71) Applicant: Andrew Shaun Knudsen, American Fork, UT (US)

(72) Inventor: Andrew Shaun Knudsen, American Fork, UT (US)

(21) Appl. No.: 14/056,494

(22) Filed: Oct. 17, 2013

Related U.S. Application Data
(60) Provisional application No. 61/715,754, filed on Oct. 18, 2012.

(51) Int. Cl. H04R 1/10

(52) U.S. Cl. CPC H04R 1/1091
USPC 381/380

(57) ABSTRACT

An audio system suppresses exterior noise and directs desired sound into a user's ear canal. An audio system may include an earplug to create a seal in the interior of an ear canal. The earplug may include a ribbed exterior profile and can be flexible to create the seal. A speaker driver may be inserted within the earplug. A distal opening may extend from the speaker driver toward the distal end of the earplug to direct sound into a user's ear canal. A proximal opening may extend from the speaker driver to the proximal end of the earplug, and can receive an audio wire connected to the speaker driver. The audio wire may connect to an audio device to allow audio data to pass through the wire and to the speaker, where it can be converted to audio that is passed directly into the ear canal of the user.

### CROSS-REFERENCE TO RELATED APPLICATIONS

This application claims the benefit of, and priority to, U.S. Patent Application Ser. No. 61/715,754 filed on Oct. 18, 2012 and titled “AUDIO LISTENING DEVICE,” which application is hereby expressly incorporated herein by this reference in its entirety.

### TECHNICAL FIELD

The present disclosure generally relates to audio output devices. More particularly, aspects of the present disclosure relate to audio output devices that also substantially block outside noise. More particularly still, aspects of the present disclosure relate generally to ear plugs configured to restrict external sound from being heard, but which also act as an earbud providing specific external sounds directly into the ear canal.

### BACKGROUND

Noise, while being an irritation, is also a cause of hearing loss when the ears are either subjected to a single loud noise or are repeatedly subjected to levels of noise above a safe level. Such noise is increasingly becoming an issue in industrial and other workplace settings where machinery operates. While some efforts may be made to reduce noise produced by machinery, the exposure to high levels of noise, or even repeated exposure to lower levels of noise, may lead to hearing loss.

For instance, the Occupational Safety and Health Administration (“OSHA”) within the United States Department of Labor has recognized that prolonged or even short exposure to some sound levels may lead to permanent hearing loss. Consequently, OSHA has set forth regulations requiring employers to develop and implement a hearing conservation program whenever exposure over an eight hour period averages 85 decibels or greater. An employer may even be required to provide protective equipment in some cases. By way of example, if an employee is subjected to sound exceeding an average of 90 decibels within an eight hour period, or sound exceeding an average of 115 decibels for fifteen minutes or less, the employer may be required to provide protective equipment. For sound levels between 90 and 115, different exposure periods may result in requirements for employer-provided ear protection.

Ear protection has traditionally taken the form of earplugs, semi-insert ear plugs, or ear muffs. Ear plugs may be pre-molded or moldable, and can be inserted in the ear to block the ear canal. Semi-insert ear plugs can include ear plugs held over the ends of the ear canal by a rigid headband. Ear muffs may include a pair of sound-attenuating ear cushions attached to hard outer cups. The ear cushions fit around the ear and the hard outer cups are connected by a head band.

Each type of ear protection may be effective in attenuating some noise, whether the noise originates at a workplace, at home (e.g., while vacuuming, in the workshop, etc.), at a sporting event (e.g., motor sports), during travel (e.g., on an airplane ride), or at other locations. The effectiveness of such devices also can provide certain drawbacks. For instance, when an earplug is in a person's ear, the person may not be able to hear music playing on the radio, hear announcements at a motorsports race, or the like. While a person could instead use an earbud connected to a radio or media player, earbuds have not traditionally been designed to prevent hearing loss. Earbuds may therefore not sufficiently attenuate external noise, thereby allowing ear damage. Headphones that do attenuate external noise (e.g., noise cancelling headphones) are traditionally large and oversized, and therefore lack discreteness, or may be easily damaged in small spaces.

### SUMMARY

In accordance with aspects of the present disclosure, embodiments of methods, systems, devices, kits, and the like are described or would be understood and which relate to audio output systems that also protect against hearing loss. An example audio system suppresses exterior noise and directs desired sound into a user's ear canal. The audio system may include an earplug to create a seal in the interior of an ear canal. The earplug may include a ribbed exterior profile and can be flexible to create the seal. To also act as an earbud, the earplug can include a speaker driver therein. The speaker driver may be in communication with a distal opening extending from the speaker driver toward the distal end of the earplug. Sound from the speaker driver may pass through the distal opening into the user's ear canal. A proximal opening may extend from the speaker driver to the proximal end of the earplug, and can receive an audio wire connected to the speaker driver. The audio wire may connect to an audio device to allow audio data to pass through the wire and to the speaker, where it can be converted to audio that is passed directly into the ear canal of the user.

Other aspects, as well as the features and advantages of various aspects, of the present disclosure will become apparent to those of ordinary skill in the art through consideration of the ensuing description, the accompanying drawings and the appended claims.

### BRIEF DESCRIPTION OF THE DRAWINGS

In order to describe the manner in which features and other aspects of the present disclosure can be obtained, a more particular description of certain subject matter will be rendered by reference to specific embodiments which are illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1 illustrates an example audio system including an integrated earbud and earplug for attenuating external noise while also providing direct input from an audio input device to a user's ear canal, according to an embodiment of the present disclosure;

FIG. 2 schematically illustrates an integrated earbud and earplug similar to that of FIG. 1, when within the ear canal of a user, according to an embodiment of the present disclosure;

FIG. 3A illustrates a cross-sectional view of an integrated earbud and earplug according to an embodiment of the present disclosure;

FIG. 3B illustrates a cross-sectional view of another integrated earbud and earplug according to an embodiment of the present disclosure;

FIG. 4 illustrates an exploded assembly view of the audio system of FIG. 1, and may further relate to a kit for forming an integrated earbud and earplug, according to an embodiment of the present disclosure;

FIG. 5 illustrates an example kit for discretely using an audio system including an integrated earbud and earplug, the kit including a lanyard in accordance with some embodiments of the present disclosure;

FIG. 6 illustrates the example kit of FIG. 5, with the audio system connected to an example lanyard, according to some embodiments of the present disclosure; and

FIG. 7 illustrates the example kit of FIGS. 5 and 6 when used by a user, in accordance with an embodiment of the present disclosure.

### DETAILED DESCRIPTION

Example embodiments of the present disclosure are directed to devices, kits, systems, and methods for attenuating sound from external sources while also delivering desired audio directly to an ear canal of a user. More particularly, example embodiments of the present disclosure are directed to systems, methods, devices, and kits that include an earplug effective in preventing or minimizing hearing loss, while also including a speaker assembly allowing the user to effectively hear desired audio. By being able to block unwanted background noise while continuing to hear desired audio, a user may have a more enjoyable shift at work, enjoy household chores while reducing risks of hearing loss, or reduce noise from fans or cars at the track while also listening in on a favorite driver's radio. Embodiments of the present disclosure may also be used in countless other environments, whether at home, school, vacation, work, or the like.

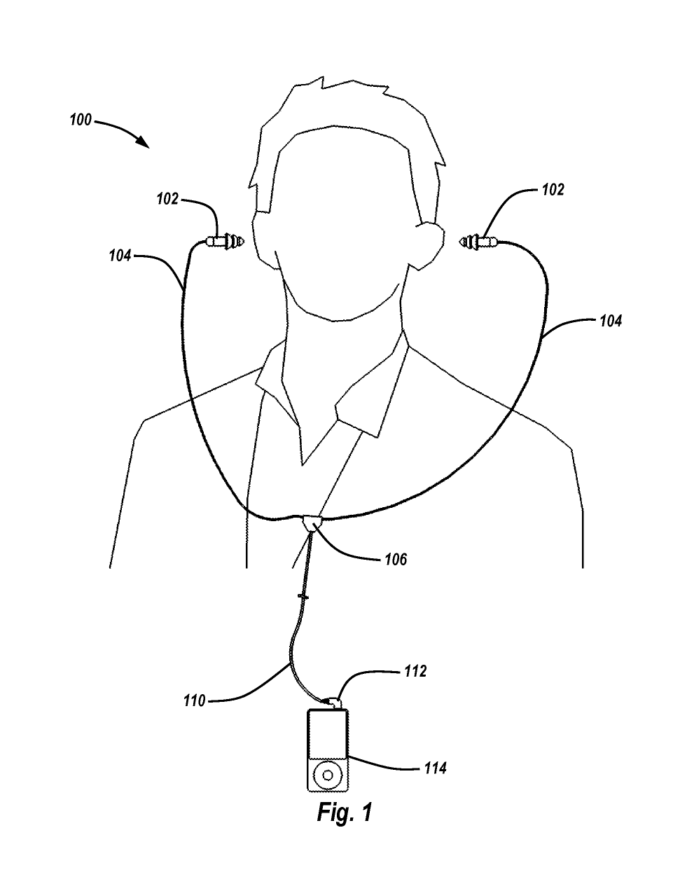

With reference now to FIG. 1, one embodiment of the present disclosure relates to an audio system 100 combining the benefits of an earplug with those of an earbud. In particular, an earplug may attenuate sound from external sources. As an example, an earbud may be tested and rated to determine its noise reduction rating. Example noise reduction ratings may decrease sound levels by twenty-five decibels or more to provide a benefit of hearing loss prevention. While an earplug may be designed primarily to reduce or attenuate sound, an earbud, in contrast, may be primarily designed to allow sound. As an example, an earbud may be connected to a portable media player or other audio source. Sound from the audio source may be provided by a speaker in the earbud. If the earbud is then in the user's ear, the audio may be played by the speaker and directly into the ear canal.

When combined as described herein, example embodiments may therefore provide sound attenuation aspects of an earplug, while also providing audio output capabilities of an earbud or headphone. Example embodiments providing such dual features may be referred to herein as “plugfones.” In particular, plugfones may include ear plugs that are also an earbud. Plugfones may offer the same level of hearing protection expected from an earplug or other sound suppressing devices, yet can allow the user to listen to music, audio books, radio, or other selected sounds at a comfortable and safe level while in a noise filled environment. Plugfones may be used in a variety of settings where the user prefers or is mandated to wear hearing protection, yet would also like the convenience or luxury of listening to audio.

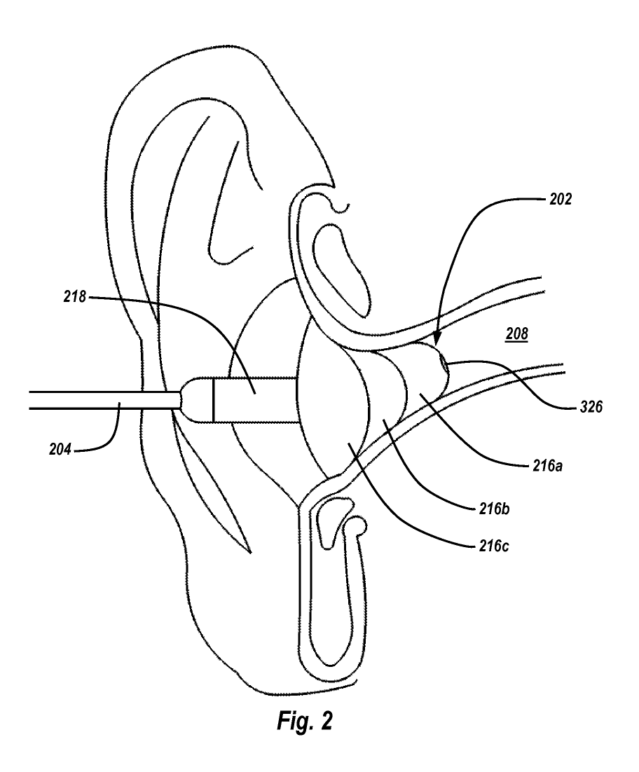

In the particular embodiment shown in FIG. 1, the audio system 100 may include a set of plugfones 102. Each plugfone 102 may be configured to be placed within the ear of a user. The particular structure or configuration of the plugfones 102 may vary. In FIG. 1, for instance, the plugfones 102 are shown as having a tapered external profile. The distal end may be narrow so as to fit within the ear canal of the user, and may then expand outward toward the proximal end. Such a profile may allow for simplified insertion and securement of the plugfones 102 within the ear canal. Optionally, the tapered profile may also, or alternatively, be flanged or ribbed. Such flanges or ribs may be flexible, and can potentially flex and create a seal within the ear canal to attenuate external noise (see FIG. 2).

The example configuration of the plugfones 102 in FIG. 1 is merely illustrative, and other configurations are contemplated. For instance, the plugfones 102 may have other profile shapes, including cylindrical, bullet-shaped, or the like. In other embodiments, the plugfones 102 may be formed of a variety of different materials (e.g., foam, memory foam, silicone, wax, thermoplastics, etc.)

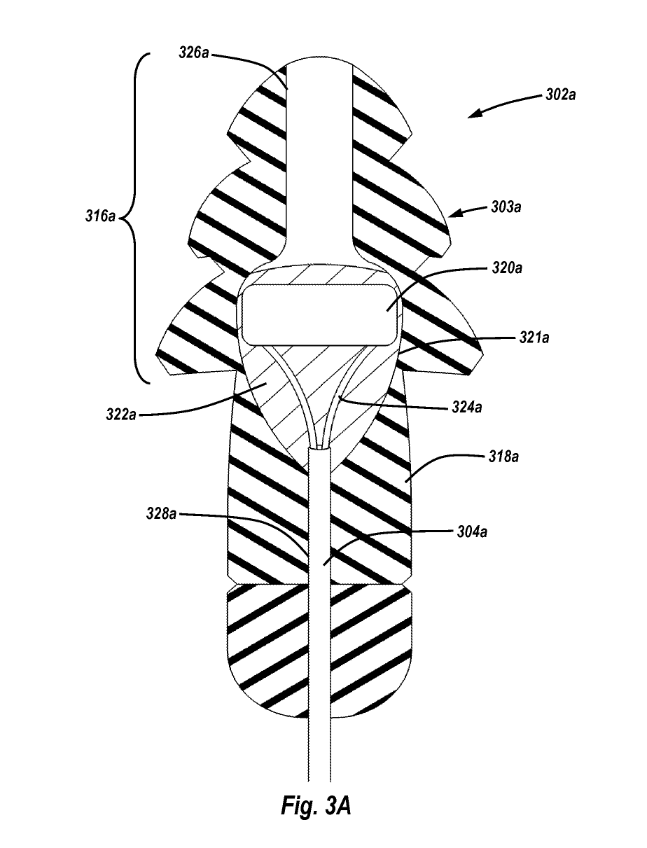

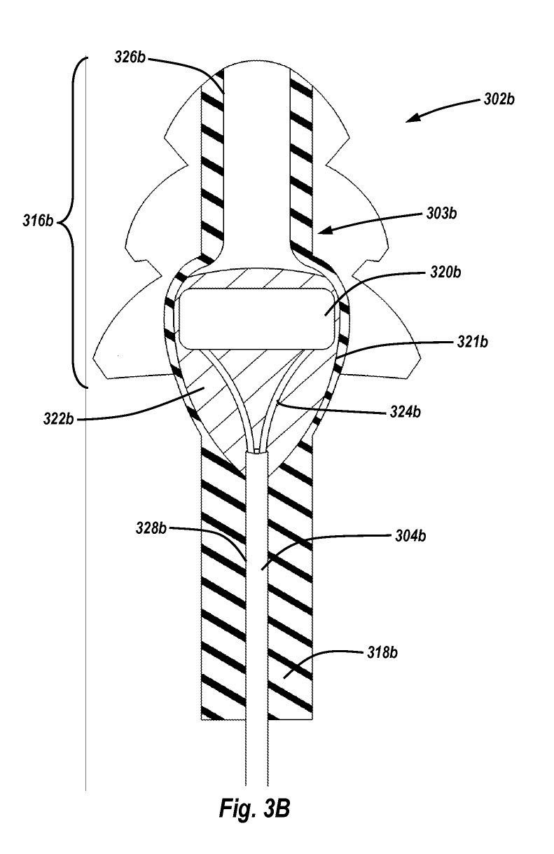

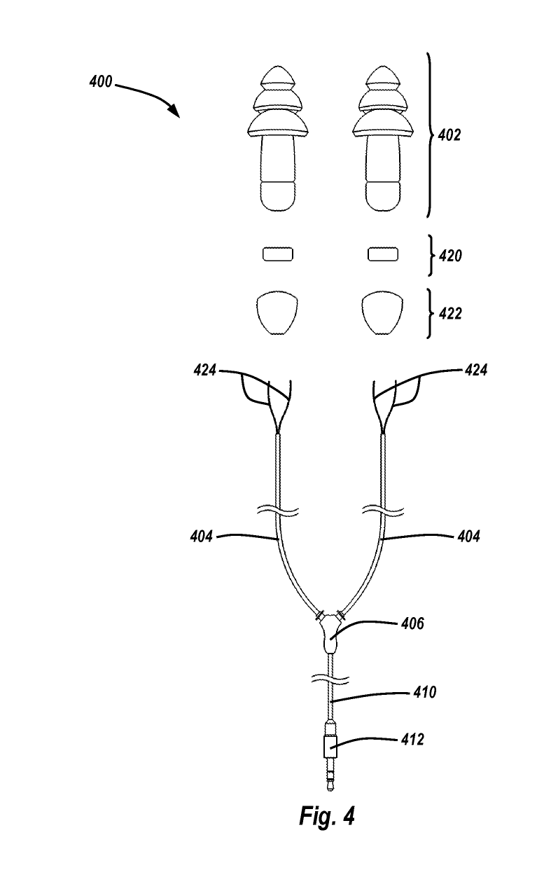

The audio system 100 of FIG. 1 also illustrates that the plugfones 102 may each be connected to an audio input. In this particular embodiment, an audio wire 104 is connected to each plugfone 102. The audio wire may generally be any wire capable of carrying acoustic, electronic, or other signals capable of being interpreted as sound. In some embodiments, a speaker (see FIGS. 3A, 3B and 4) may be located within the plugfones 102 and also connected to the wire 104 to convert a signal into a sound that is audible to the human ear.

According to some embodiments, the audio wires 104 may be separate, while in other embodiments the audio wires 104 may be at least partially combined. In FIG. 1, for instance, a junction 106 is provided at a medial portion of the audio system 100. The audio wires 104 may each connect to the junction 106 and extend therefrom. At a lower portion of the junction 106, however, there may be a single audio wire 110. The audio wire 110 may effectively combine the audio sent through each of the audio wires 104. Optionally, the junction 106 may electronically join the audio wires 104 into the single audio wire 110, although in other embodiments the junction 106 may only physically join the wires 104 such that they are maintained electronically separate.

While the junction 106 is described as joining the audio wires 104, it may also be described as a splitter. For instance, the combined audio wire 110 may connect to an audio input 112 which in turn connects to an audio output of a playback device such as audio device 114. The audio device 114 may provide sound that is conveyed through the audio input 112 to the combined audio wire 110. The junction 106 may then split the combined wire 110 into separate audio wires 104 that each have the same or different audio to output. Thus, in some embodiments, each audio wire 104 provides the same audio to a respective plugfone 102. In other embodiments, such as in the case of stereo sound, different audio signals, or channels, may be provided to each audio wire 104, and thus to each plugfone 102.

While the junction 106 may split the sound conveyed using the combined audio wire 110, in other embodiments different components may split the sound and/or the wires. For instance, the combined audio wire 110 may physically connect to electronically separated audio wires. The audio input 112 may, however, provide two different connections and thereby separate audio provided by the audio device 114.

In some embodiments, the audio input 112 may include an audio jack. For instance, a 3.5 mm jack may be used and inserted into a corresponding jack on the audio device 114. The audio device 114 may itself have any of configurations or uses. In some embodiments, the audio device 114 may include a personal media player, smart phone, radio, or the like.

In general, the collective length of the audio wires 104, 110 may be sufficient to allow comfortable use of the plugfones 102 with the audio device 114. Such length may thus vary based on any of conditions or considerations. In at least some embodiments, the collective length of the audio wires 104, 110 may be between about 0.5 meter to about 3 meters, although the length may be larger or smaller in other embodiments. In a more particular embodiment, the length may be between about 1 meter and about 2 meters. In still another more particular embodiment, the collective length of the audio wires 104, 110 may be between about 1 meter and about 1.5 meters. In still another embodiment, the length may be about 1.2 meters ±0.25 meter.

As discussed herein, an aspect of embodiments of the present disclosure is the ability of a plugfone 102 to not only suppress external noise from a user, but to also directly convey desired noise to the ear canal of a user. FIG. 2 schematically illustrates an example embodiment of an ear of a user when a plugfone 202 is inserted therein. In this particular embodiment, the plugfone 202 may be generally tapered and flanged/ribbed. For instance, FIG. 2 illustrates the plugfone 202 as including three flanges/ribs 216a-216c, although any of flanges or ribs may be used. In this particular example, a distal-most rib 216a has a smallest cross-sectional diameter or size, while the proximal-most rib 216c has the largest cross-sectional diameter or size. The medial rib 216b may have a size between that of the adjacent ribs 216a, 216c.

The increasing size of the ribs 216a-216c from the distal to proximal ends of the plugfone 202 may allow for the plugfone 202 to be easily inserted from the exterior of the ear, and into the ear canal 208. The proximal end of the ear canal 208 may also have a generally tapered shape. Thus, the tapered shape of the plugfone 202 may generally conform to the shape of the entrance to the ear canal 208. As also shown in FIG. 2, the ribs 216a-216c may be generally deformable. The ribs 216a-216c may bend, flex, or otherwise conform to the shape of the ear canal 208, and may thereby create a seal within the ear canal 208 to suppress sounds from passing through the ribs 216a-216c and into the inner ear.

As also shown in FIG. 2, however, the rib 216a may have an opening 226. The opening 226 may provide an audio passageway for preferred sounds to be directed into the ear canal 208. As discussed herein, an audio wire 204 may connect to the plugfone 202 to direct audio into the ear canal 208. In this particular embodiment, the plugfone 202 includes an example stem 218 connected to the ribs 216a-216c. The stem 218 may in turn connect to, and potentially receive therein, the audio wire 204. A speaker driver (not shown) may be located within the plugfone 202 and can be connected to the audio wire 204. The speaker may receive electrical or other signals from the audio wire 204 and convert them into audio that may pass through the opening 226 and into the ear canal 208.

FIGS. 3A and 3B illustrate more particular examples of plugfones 302a, 302b that may be used in accordance with some embodiments of the present disclosure. In these particular embodiments, cross-sectional views are provided to illustrate example interiors of the plugfones 302a, 302b. More particularly, the plugfone 302a of FIG. 3A may include a body 303a that includes a set of multiple ribs/flanges 316a and a stem 318a. In general, the flanges/ribs 316a may provide a sealing element used to create a seal within an ear of a user (see FIG. 2). In contrast, the stem 318a may act as a structural element for supporting the flanges/ribs 316a, to facilitate handling of the plugfone 302a, or for other purposes.

The stem 318a may generally be located at a proximal side or end of the plugfone 302a, while the flanges/ribs 316a may be at the distal end thereof. As shown in FIG. 3A, the body 303a may define an opening 326a extending proximally from the distal end of the flanges/ribs 316a. Although not necessary for all embodiments, the opening 326a may extend longitudinally through all or a portion of the body 303a. In this particular example, the opening 326a may be configured to allow audible sounds produced within the body 303a to pass distally through the opening 326a and into the ear canal of a user or wearer of the plugfone 302a.

To allow production of the sounds, the plugfone 302a further may include a speaker driver 320a. As shown in FIG. 3A, the speaker driver 320a may be located within the interior of the body 303a, and more specifically within a chamber 321a in fluid communication with the opening 326a. In some embodiments, the chamber 321a is larger than the opening 326a. For instance, the speaker driver 320a may be sized larger than the opening 326a, such that the chamber 321a may also be larger to accommodate the speaker driver 320a. In at least some embodiments, the chamber 321a may be initially formed as part of the opening 326a, but may be stretched or otherwise deformed by the speaker driver 320a to enlarge the chamber 321a.

In at least some embodiments, the speaker driver 320a may be fully or partially enclosed within a casing 322a, such that the casing may enlarge or deform the chamber 321 in some embodiments. As shown in FIG. 3A, the casing 322a may also be located within the chamber 321a. Optionally, the casing 322a may be specially designed for use with the speaker driver 320a. Thus, the casing 322a may include an opening sized to receive the speaker driver 320a and/or one or more wires 324a connected to the speaker driver 320a. The casing 322a may further be designed to enable audio sounds produced with the speaker driver to be projected through the opening 326a and into the ear canal of a listener at a safe level. The casing 322a may also be used or designed to protect the speaker driver 320a from damage.

The casing 322a may be formed of any of materials and have a variety of different features. For instance, the casing 322a may be formed of the same material as the body 303a. In other embodiments, however, the casing 322a and body 303a may be formed of different materials. As an example, the body 303a may be formed of a foam or silicone material. The casing 322a, in contrast, may be formed of a more rigid thermoplastic material such as ABS. Of course, other polymeric, composite, organic, metallic, or other materials may also be used. For instance, acetal, nylon,

As shown in FIG. 3A, the body 303a may also include the stem 318a extending proximally from the flanges/ribs 316a. According to some embodiments, the stem 318a may be integrally formed with at least some of the flanges/ribs 316a. In this particular embodiment, at least a portion of the stem 318a may be integrally formed with the flanges/ribs 316a, and may thus be formed of the same material. Optionally, an end cap of the stem 318a may be provided and formed of a different material and/or be the same material but not integrally formed with a portion of the stem 318a and/or the flanges/ribs 316a.

In FIG. 3A, the stem 318a also has an opening 328a therein. In this particular embodiment, the opening 328a may extend from the proximal end of the stem 318a and to the chamber 321a. The opening 328a may be sized to receive an audio wire 304a which may be connected to an audio device as described herein. The audio wire 304a optionally includes one or more additional wires 324a, which connect to the speaker driver 320a. Thus, the wire 304a may carry electronic signals through the stem 318a and to the speaker driver 320a to allow audio to be created and passed through the opening 326a. According to at least some embodiments, the wire 304a may substantially block the opening 328a so as to limit external sounds from passing through the stem 318a and into the body 303a. In other embodiments, the wire 304a and the casing 322a may collectively suppress external noise by blocking the transmission of such noise through the body 303a.

FIG. 3A illustrates an example embodiment in which the body 303a has a generally uniform construction that includes both the flanges/ribs 316a and the stem 318a. In other embodiments, however, a plugfone may have an alternative or different construction. FIG. 3B, for instance, illustrates a plugfone 302b having a similar shape, but different interior construction.

More particularly, in the embodiment shown in FIG. 3B, a plugfone 302b may include a body 303b having a generally tubular construction. In this particular embodiment, the body 303b may be connected to a set of flanges/ribs 316b, but the body 303b itself may extend longitudinally through the interior of the plugfone 302b. The body 303b may have openings at the distal end proximal ends. For instance, a distal opening 326b may extend from the distal end of the body 303b to a medial portion of the body 303b. In this embodiment, the medial portion may include a chamber 321b where the speaker driver 320b and casing 322b are located. Similarly, a proximal opening 328b may extend from the proximal end of the body 303b (e.g., a proximal end of the stem 318b) to the chamber 321b or some other medial portion of the body 303b.

Optionally, the generally tubular structure of the body 303b may be generally uniform along a length thereof. In FIG. 3B, however, various portions may be differently configured. As an example, the openings 326b and 328b may have different sizes. Although merely illustrative, the opening 326 may be about three times the diameter as the opening 328b. Of course, by increasing or decreasing a size of the audio wire 304b, by increasing or decreasing the amount of audio desired through the opening 326b, or the like, the relative dimensions may change. Moreover, the width of the body 303b is shown to be about constant at the distal and proximal ends thereof, with a wider size at the medial portion corresponding to the chamber 321b and the casing 322b. In view of opening 326b being larger than opening 328b, the wall thickness may also vary; however, in other embodiments wall thickness may be generally constant throughout.

It should be appreciated that the particular dimensions of elements of a plugfone may vary according to any suitable conditions or requirements. To merely illustrate some example embodiments, FIG. 3B will be described with respect to specific dimensions; however, such dimensions may be varied as desired.

According to an example embodiment, the body 303b may have a length of about three centimeters, although such size may be increased or decreased in other embodiments. In at least one embodiment, a width of the body may be about five millimeters at the distal end proximal ends thereof, and about nine millimeters at the widest portion of the body 303b (e.g., corresponding to the widest portion of the chamber 321b and/or casing 322b). In such an embodiment, the speaker driver 320b may be a seven millimeter speaker driver. The casing 322b optionally has a size allowing insertion of the casing 322b into the body 303b while also allowing the earplug to fit comfortably within the user's ear. As shown in FIG. 3B, the casing 322b could have a generally tear-dropped or otherwise tapered shape. Other designs could, however, be included.

Optionally, the distal opening 326b may be about three millimeters in diameter, while the proximal opening 328b may be about one millimeter in diameter. As a result of such dimensions, the wall thickness of the body 303b may vary from about two millimeters in the stem 318b, to one millimeter around the distal opening 326b. Around the casing 322, the wall thickness of the body 303b may also be about one millimeter, but may also be less (e.g., about one-half millimeter) around the chamber 321b.

In at least some embodiments of the present disclosure, the chamber 321b and the increased width of the body 303b around the chamber 321b, may be formed by stretching the material forming the body 303b. For instance, the body 303b may be formed to be generally tubular with a constant width. Optionally, the casing 322b, speaker driver 322b and wire 304b may initially be located outside of the body 303b. Such components may then be connected and inserted into the body 303b. As an example, the audio wire 304b may be inserted through the opening 328b and the opening 326b, to pass fully through the body 303b. The wires 324b may be connected to the speaker driver 320b, and the wires 324b and speaker driver 320b may then be placed within the casing 322b. The wire 304b may then be drawn in a proximally-directed direction to pull the speaker assembly through the opening 326b and into the chamber 321b. Pulling the speaker assembly in this manner may cause the opening 326b to temporarily deform and increase size. Ultimately, the speaker assembly may reach the chamber 321b which can also be stretched to accommodate the casing 322b, speaker driver 320b, and audio wire 304b.

With reference now to FIG. 4, an exploded view of an example audio system 400 is provided to further describe and illustrate some aspects of the present disclosure. The audio system 400 may generally include components similar to those shown and described relative to FIGS. 3A and 3B. Accordingly, to avoid unnecessarily obscuring aspects of the present disclosure, certain features or aspects may be omitted when describing FIG. 4; however, the disclosure herein related to other figures, including FIGS. 3A and 3B, should be understood by a person having ordinary skill in the art to be equally applicable to FIG. 4.

More particularly, the audio system 400 of FIG. 4 includes a dual-earplug system that includes two plugfones 402 that may be configured for use in not only blocking ambient or external noise, but also in delivering desired audio produced using a speaker driver 420. In operation, the speaker driver 420 may receive audio information from one or more audio wires. As shown in FIG. 4, for instance, each speaker driver 420 may be connectable to a pair of leads 424 of an audio wire 404. The audio wires 404 may in turn be joined at a junction 406 into a combined audio wire 410 that connects to an audio input 412, represented here as a 3.4 mm jack. The audio input may be connected to a playback or audio device (not shown).

To assemble the audio system 100, the leads 424 may be connected to a corresponding speaker driver 420. Optionally, the speaker driver 420 may be located within a casing 422. The casing 422 may be designed to protect the speaker driver 420 and/or to deliver audio. Once the leads 424, speaker driver 420, and casing 422 are connected together, they may be inserted into a corresponding plugfone 402 (e.g., through one or more openings therein).

The casing 422 may be secured within the plugfone 402 in a number of suitable manners. For instance, the plugfone 402 may be configured to be replaceable. In such an embodiment, the casing 422 may be slid into the earplug and secured using a compression fit, frictional fit, or other mechanism that allows selective removal of the casing relative to the earplug. As also shown in some figures herein, some embodiments contemplate that the speaker driver 420 may be located wholly within the plugfone 402, such that only the audio wire 404 may extend out of the plugfone body or stem.

According to at least some embodiments, the audio wire 404, casing 422, and speaker driver 420 may be assembled together as a speaker assembly that is wholly separate from a plugfone 402. Thereafter, the speaker assembly may be inserted through an opening in the plugfone 402 and into the interior of the plugfone 402. In other embodiments, assembly may occur while one or more components are within the plugfone 402. For instance, as described herein, one embodiment may contemplate inserting the audio wire 404 through the plugfone 402 and then assembly the speaker assembly. After assembly, the speaker assembly may be drawn down into the interior of the plugfone 402.

As noted herein, the audio system 400 may be configured to be permanent, or one or more components may be replaceable. In accordance with at least some embodiments, some or all components of the audio system 400 may be provided as a kit. As an example, a kit may include two or more of the speaker driver 420, casing 422, audio wires 404, 410, junction 406, or audio input 412. Such components may be provided in an assembled or disassembled state, but may be separate from the plugfones 402. This type of a kit may allow a user to assembly his or her own speaker assembly and then select any desired type of earplug or other component to use as plugfones 402. Assembly in such case may also include creating one or more openings in the plugfone 402 to allow insertion of the speaker assembly. Such a kit may also may allow the speaker assembly to be modular and interchangeable. A user could replace the plugfones 402 as needed with different plugfones, including plugfones of different shapes, styles, colors, and the like.

In other embodiments, however, a kit may be formed using the components of FIG. 4, while including the plugfones 402. For instance, the audio system 400 may be provide in the disassembled state shown in FIG. 4 to allow assembly by a user. Alternatively, various components may already be assembled. As an example speaker drivers 420 and/or casings 422 may already be connected to the leads 424. In such a case, the user may merely need to insert the speaker assemblies into respective plugfones 402 to begin using the audio system 400. Of course, packaging, written instructions, and the like can be used in connection with providing some or all components of the audio system 400 as a kit.

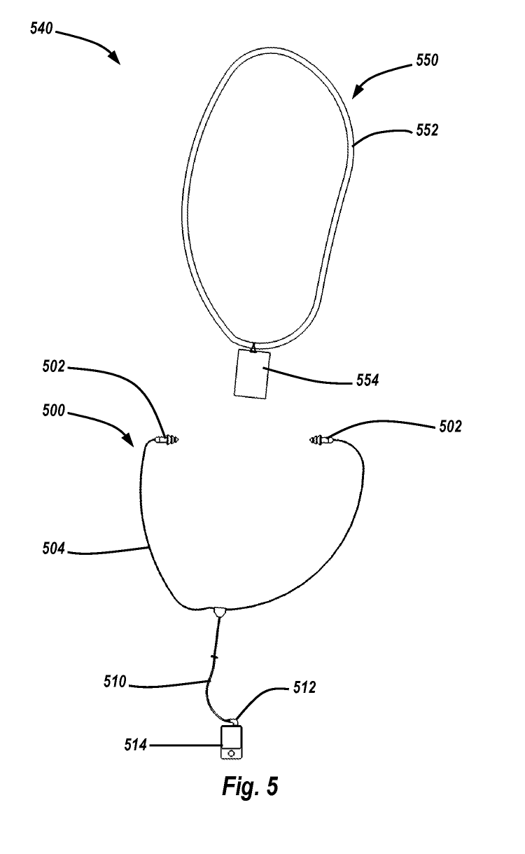

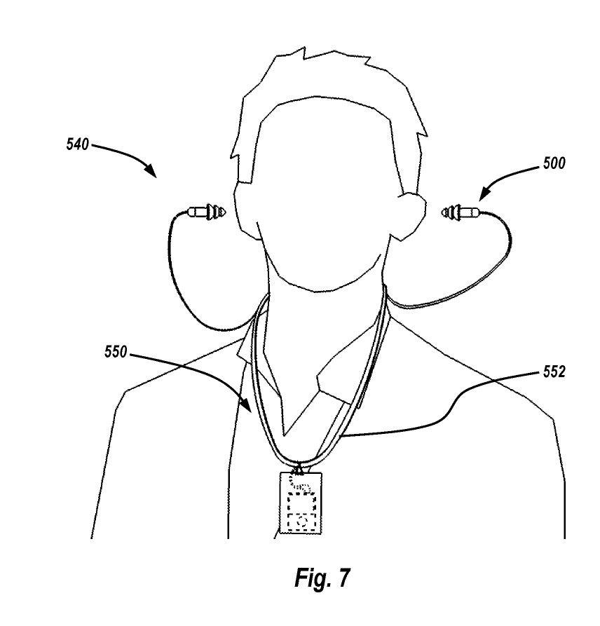

Another example kit 540 usable in connection with some embodiments of the present disclosure is shown and described relative to FIGS. 5-7. In this particular example embodiment, the kit 540 may include some or all of the components described with respect to FIG. 4. As particularly shown in FIG. 5, an audio system 500 may be assembled; however, the kit may include the audio system 500 in a disassembled state. Optionally, the kit 540 may also include a lanyard assembly 550. In some embodiments, the lanyard assembly 550 may include only a lanyard 552. As best shown in FIG. 7, the lanyard 552 can be placed over the head of a user and around such a user's neck. Optionally, the lanyard 552 may be used to obscure one or more wires of the audio system 500. For instance, the assembled audio system 500 may be connected to the lanyard 552 in a manner that hides the audio wires 504, 510 and/or makes such wires 504, 510 more discrete.

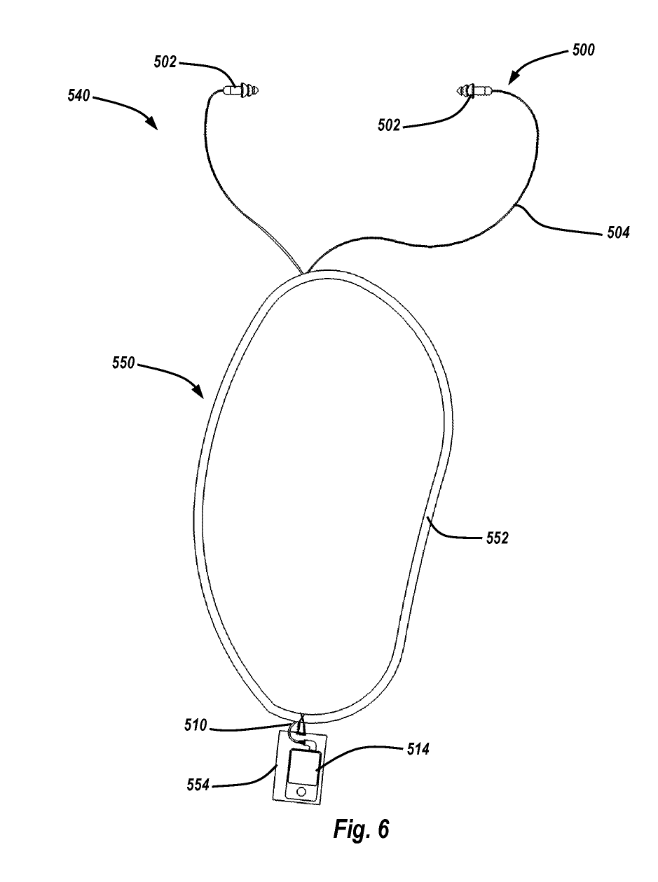

As shown in FIG. 6, for instance, the audio wires 504 may be connected at, or potentially inserted within, the lanyard 552 at a rear location thereof. The rear location may correspond to a location that will be placed at the back of the user's neck as shown in FIG. 7. Once connected to the lanyard 552, the audio wires 504, as well as the combined audio wire 510, may extend along or through the lanyard 552, to be obscured thereby. The wires 504, 510 may extend around to a front side of the lanyard 552 by extending in a single direction, or in two directions, around the lanyard 552. Optionally, a badge 554, carrier, or other similar element may also be provided and connected to the lanyard 552. As best shown in FIGS. 6 and 7, the distal end of the audio wire 510 may extend out of the lanyard 552 and down into the badge 554. An audio device 514 may optionally be placed within, or behind, the badge 554. The audio device 514 may thus not only be conveniently carried, but may also be covered to hide the audio device 514 from view and/or protect the audio device 514 from damage.

In the kit 540 of FIGS. 5-7, the kit may be constructed of any of different elements, any or all of which may be assembled or disassembled. Thus, a kit 540 may include a lanyard 552 and a badge 552, or may only include one or the other. The audio system 500 may also be included in such a kit 540 with or without the plugfones 502 and/or in an assembled or disassembled state.

The lanyard 552 and/or badge 554 are merely illustrative of some embodiments of features that may be used to discretely use the audio system 500. In other embodiments, for instance, the audio device 514 may be placed within a pocket in clothing. The audio wires 504, 510 may then run on the inside or outside of clothing and to the user's ears. In some embodiments, clothing may include channels to receive the wiring directly therethrough, or may include wiring built in so that the audio input 512 can be connected to the clothing, and the clothing itself may then connect to the audio device 514. Of course backpacks, hats, and other clothing or accessories may also be used to discreetly or safely use an audio system as described herein.

Those skilled in the art will therefore appreciate that the embodiments may be practiced in a variety of environments, to satisfy a of different functions or purposes. For instance, manufacturing and industrial workers may use plugfones as described herein to protect their hearing. As an example, workers in assembly lines who find themselves around loud machinery may use plugfones to reduce the noise of the machinery and/or better hear music or other audio provided through the plugfones. Operators of heavy equipment may also use plugfones, as may riders of motorcycles (e.g., for reduced road or exhaust pipe noise). Students who are looking for a quiet studying environment may also use plugfones. NASCAR, NHRA, and team sport fans looking to reduce the noise of the race cars or game noise yet who want to listen to driving teams, commentators, or the like via a radio or other broadcast may also use plugfones. Everyday users may use plugfones while operating lawnmowers, weed eaters, chainsaws, woodworking tools, vacuums, etc.

Although the foregoing description contains many specifics, these should not be construed as limiting the scope of the invention or of any of the appended claims, but merely as providing information pertinent to some specific embodiments that may fall within the scopes of the invention and the appended claims. Various embodiments are described, some of which incorporate differing features. The features illustrated or described relative to one embodiment are interchangeable and/or may be employed in combination with features of any other embodiment herein. In addition, other embodiments of the invention may also be devised which lie within the scopes of the invention and the appended claims. The scope of the invention is, therefore, indicated and limited only by the appended claims and their legal equivalents. All additions, deletions and modifications to the invention, as disclosed herein, that fall within the meaning and scopes of the claims are to be embraced by the claims.

What is claimed is:

1. An audio system, comprising:
an earplug adapted to fit within an ear canal of a user and suppress external sound, the earplug having a ribbed exterior profile and having openings at distal and proximal ends thereof;
an audio wire passing through an opening at a proximal end of the earplug; and
a speaker driver within the earplug and attached to the audio wire, the speaker driver being configured to receive audio data from the audio wire and output audio through the opening at the distal end of the earplug.

2. The audio system recited in claim 1, wherein the earplug is adapted to provide at least a twenty-five decibel decrease to external sounds.

3. The audio system recited in claim 1, wherein the earplug is tapered.

4. The audio system recited in claim 1, further comprising a casing around the speaker driver.

5. The audio system recited in claim 4, wherein the earplug is deformable and the casing is substantially rigid.

6. The audio system recited in claim 1, wherein the earplug is silicone.

7. The audio system recited in claim 1, wherein the earplug is a first earplug, the audio system further comprising a second earplug configured substantially identically relative to the first earplug.

8. The audio system recited in claim 1, further comprising a lanyard connected to the audio wire.

9. The audio system recited in claim 8, wherein the audio wire is connected to a rear side of a lanyard.

10. The audio system recite din claim 9, wherein a proximal end of the audio wire extends out of a front side of the lanyard.

11. The audio system recited in claim 10, wherein the proximal end of the audio wire extends into a badge connected to the lanyard.

12. The audio system recited in claim 8, wherein the lanyard substantially obscures a length of the audio wire.

13. A method, comprising:
accessing a speaker assembly comprising:
a speaker driver;
a wire electrically coupled to the speaker driver; and
a casing substantially enclosing the speaker drive rand at least a portion of the wire; and
inserting the speaker assembly into an earplug having openings on distal ends thereof, the earplug having a ribbed exterior profile;
securing the speaker assembly within the earplug such that the speaker driver is wholly within the earplug.

14. The method recited in claim 13, further comprising:
connecting the wire to the speaker driver;

15. The method recited in claim 14, wherein connecting the wire to the speaker driver includes connecting a pair of wire leads to the speaker driver.

16. The method recited in claim 14, wherein inserting the speaker assembly into the earplug includes retracting the wire within the earplug to slide the speaker assembly into the earplug.

17. An audio kit, comprising:
a set of two speaker drivers;
a set of two casings, each casing being configured to receive a respective speaker driver therein; and
an audio wire, the audio wire including an input at a proximal end thereof, the audio wire further splitting into two separate audio wires at a distal end thereof.

18. The kit recited in claim 17, further comprising:
two earplugs, wherein the speaker drivers and casings are sized and configured to be positionable wholly within the earplugs.

19. The kit recited in claim 17, further comprising:
a lanyard configured to receive an audio wire and obscure the audio wire as it extends around at least a portion of the lanyard.

20. The kit recited in claim 19, further comprising:
a badge connectable to the lanyard at a location where a proximal end of the audio wire may extend out of the lanyard.
